(19) United States
(12) Patent Application Publication
(10) Pub. No.: US 2025/0292534 A1
(43) Pub. Date: Sep. 18, 2025

(54) INFORMATION PROCESSING APPARATUS, DISPLAY CONTROL METHOD, AND STORAGE MEDIUM

(71) Applicant: CASIO COMPUTER CO., LTD., Tokyo (JP)

(72) Inventor: Kazuhisa MATSUNAGA, Tokyo (JP)

(73) Assignee: CASIO COMPUTER CO., LTD., Tokyo (JP)

(21) Appl. No.: 19/081,621

(22) Filed: Mar. 17, 2025

(30) Foreign Application Priority Data
Mar. 18, 2024 (JP) 2024-042456

(51) Int. Cl. G06V 10/60; G02B 5/30; G06T 5/50; G06V 10/141; G06V 10/25

(52) U.S. Cl. CPC G06V 10/60; G02B 5/30; G06T 5/50; G06V 10/141; G06V 10/25; G06T 2207/20221

(57) ABSTRACT

An information processing apparatus 100 includes one or more processors configured to: acquire a first image including a region of interest which is irradiated with first illumination light and imaged by an imaging element via a polarizing filter 31, and a second image including the region of interest which is irradiated with second illumination light and imaged by the imaging element without using the polarizing filter 31, and cause a display device 10 to switch between the first image and the second image in a state in which a position of the region of interest in the first image and a position of the region of interest in the second image substantially coincide with each other.

### CROSS-REFERENCE TO RELATED APPLICATIONS

This application claims priority to and the benefit of Japanese Patent Application No. 2024-042456 filed on Mar. 18, 2024. The entire specification, claims, and drawings of Japanese Patent Application No. 2024-042456 are incorporated herein by reference.

### BACKGROUND

### Field

The present disclosure relates to an information processing apparatus, a display control method, and a storage medium.

### Background

As described in JP 2016-214552 A, a technique for observing a subject while switching between polarization observation and non-polarization observation with a dermoscope is known.

### SUMMARY

An information processing apparatus according an aspect of the present invention includes one or more processors configured to: acquire a first image including a region of interest which is irradiated with first illumination light and imaged by an imaging element via a polarizing filter, and a second image including the region of interest which is irradiated with second illumination light and imaged by the imaging element without using the polarizing filter, and cause a display to switch between the first image and the second image in a state in which a position of the region of interest in the first image and a position of the region of interest in the second image substantially coincide with each other.

### BRIEF DESCRIPTION OF THE DRAWINGS

FIG. 1 is a diagram illustrating an example of configuration of a system according to an embodiment of the present invention;

FIG. 2 is an example of a flowchart of a process performed by the system illustrated in FIG. 1;

FIG. 3 is a diagram illustrating a flow of image processing in the process illustrated in FIG. 2;

FIG. 4 is a diagram illustrating exchange between apparatuses constituting the system illustrated in FIG. 1;

FIG. 5 is an example of a flowchart of a process for obtaining images illustrated in FIG. 2;

FIG. 6 is another example of the flowchart of the process performed by the system illustrated in FIG. 1; and

FIG. 7 is yet another example of the flowchart of the process performed by the system illustrated in FIG. 1.

### DETAILED DESCRIPTION

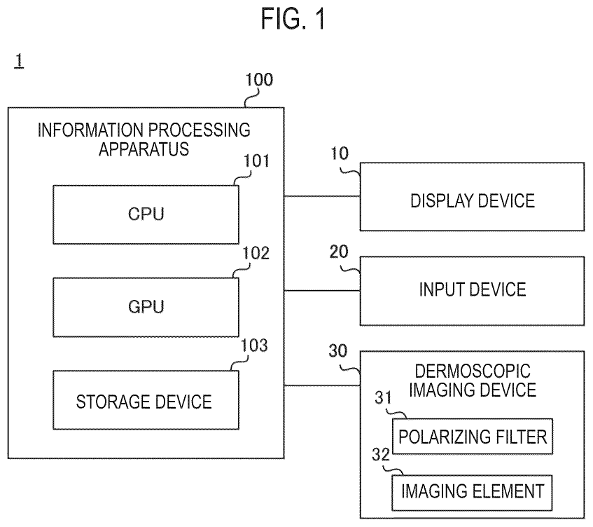

A user of a system 1 of FIG. 1 is, for example, a doctor who diagnoses a skin tumor. The system 1 includes an information processing apparatus 100 and peripheral devices (a display device 10, an input device 20, and a dermoscopic imaging device 30) connected to the information processing apparatus 100. The display device 10 is an example of a display that displays information to the user of the information processing apparatus 100. The display device 10 is, for example, a liquid crystal display, an organic EL display, or the like. The input device 20 is an example of an input unit that receives the user's operations on the information processing apparatus 100. The input device 20 is, for example, a keyboard, a mouse, a touch panel, or the like. Note that although an example in which the information processing apparatus 100 is directly connected to the peripheral devices (in particular, the dermoscopic imaging device 30) has been described in this example, the information processing apparatus 100 may be an information processing apparatus connected to the dermoscopic imaging device 30 over a network such as the Internet, instead, and may be, for example, a server.

A dermoscope is a magnifier that can be used to magnify and non-invasively observe a lesion in a patient suspected of a malignant skin tumor. The lesion of a patient suspected of a malignant skin tumor is an example of a region of interest of the user, and is typically a mole or a wart on the skin that is a subject. The dermoscopic imaging device 30 is an example of an imaging unit that images a subject (skin) including a region of interest (a mole, a wart, etc.), and generates a dermoscopic image of the subject. The dermoscopic imaging device 30 includes a polarizing filter 31 and an imaging element 32 effective in reducing an effect of light reflected from a skin surface. The dermoscopic imaging device 30 can switch between imaging with the polarizing filter 31 and imaging without the polarizing filter 31, and in particular, has a continuous imaging function of continuously imaging a subject S by inserting and removing the polarizing filter 31 into and from an optical path in response to one operation performed by the user. Furthermore, the dermoscopic imaging device 30 may also be capable of imaging with ultraviolet (UV) light. Imaging with UV light makes it possible to obtain a dermoscopic image reflecting characteristics of melanin that absorbs UV light and a fluorescence response due to the UV light, and is suitable for identification of skin tumors as with an image in which the effect of light reflected from the skin surface is reduced.

The information processing apparatus 100 is a general-purpose or dedicated computer including a CPU 101, a GPU 102, and a storage device 103. The CPU101 and the GPU102 are processors that execute various types of processing, that is, processing units, and operate as an obtaining unit 110 and a display control unit 120, which will be described later, by executing a program stored in the storage device 103. In the information processing apparatus 100, one or more processors may operate, that is, one processor may perform processing described later alone or a plurality of processors may perform the processing described later in cooperation with one another. The storage device 103 stores programs to be executed by the processors such as the CPU101 and the GPU102, data to be used when the programs are executed, and the like. The storage device 103 includes, for example, a semiconductor memory that operates as a main storage device, such as a random-access memory (RAM) or a read-only memory (ROM), and a storage that operates as an auxiliary storage device, such as a solid-state drive (SSD) or a hard disk drive (HDD).

Specific structures of the skin that is the subject are more conspicuous in dermoscopy with the polarizing filter 31, while other specific structures are more conspicuous in dermoscopy without the polarizing filter 31. Some of these specific structures are useful in the diagnosis of skin tumors, such as shiny white structures. The shiny white structures are an example of particularly conspicuous structures in the dermoscopy with the polarizing filter 31, and suspected to be correlated with malignant skin tumors. In addition, skin wrinkles are more conspicuous in the dermoscopy without the polarizing filter 31 than in the dermoscopy with the polarizing filter 31. These specific structures appear to blink and can be observed better by switching between the dermoscopy with the polarizing filter 31 and the dermoscopy without the polarizing filter 31. In the observation performed while switching between the dermoscopy with the polarizing filter 31 and the dermoscopy without the polarizing filter 31, therefore, it is easy to identify these structures, and diagnostic sensitivity is expected to improve. Work of manually switching between the dermoscopy with the polarizing filter 31 and the dermoscopy without the polarizing filter 31, and in particular work of repeatedly switching over and over so that specific structures appear to blink, however, is a heavy burden on the user. In addition, manual switching is likely to cause, for example, a shift in an imaging position.

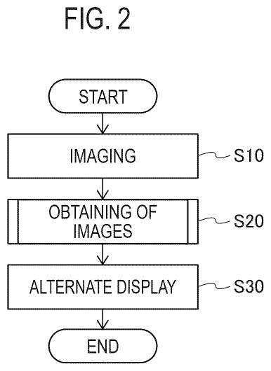

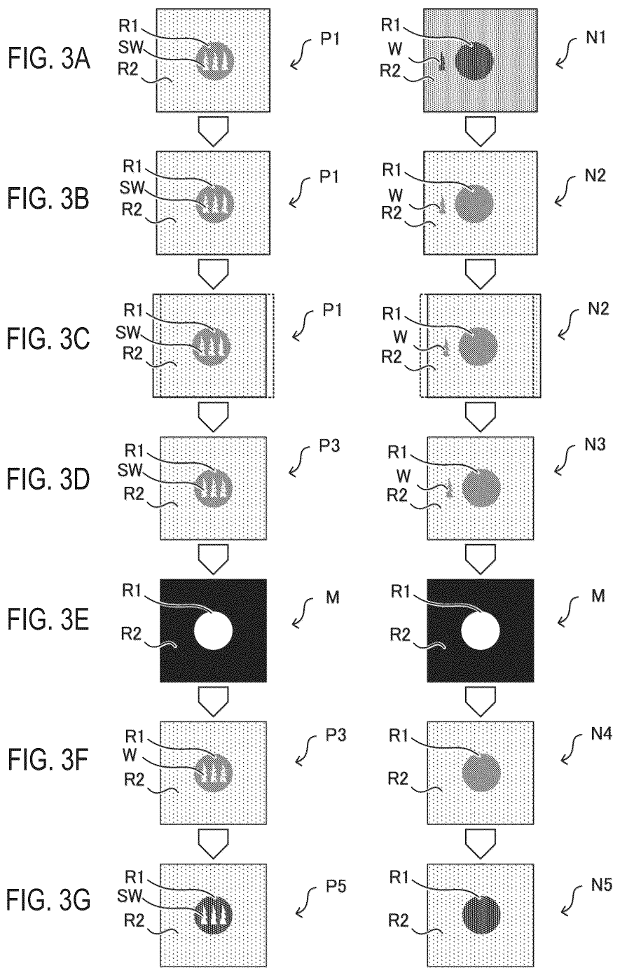

Operation of the system 1 used to diagnosis a malignant skin tumor will be specifically described with reference to FIGS. 2 to 5. As illustrated in FIG. 2, the processing performed by the system 1 includes imaging (step S10), obtaining of images (step S20), and alternate display (step S30). In step S10, an image P1 and an image N1 illustrated in (a) of FIG. 3 are generated. In step S20, image processing illustrated in (b) to (g) of FIG. 3 is performed on the image P1 and the image N1 generated in step S10 to obtain an image P5 and an image N5. In step S30, the image P5 and the image N5 obtained in step S20 are alternately displayed, that is, the image P5 and the image N5 are alternately displayed repeatedly (loop display). Each step will be described in more detail hereinafter.

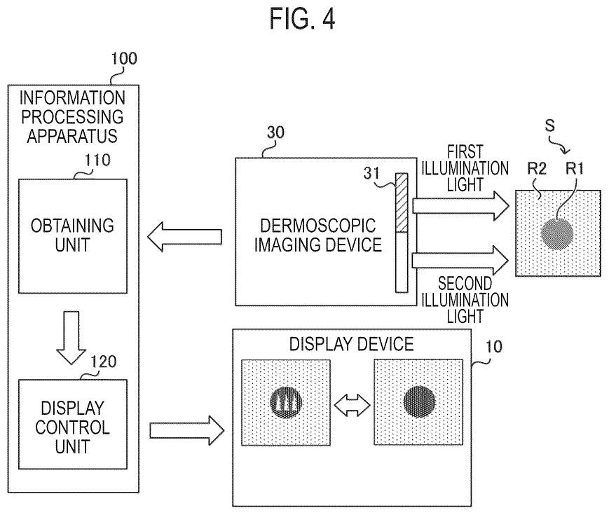

The imaging in step S10 is performed in accordance with an imaging operation performed by the doctor. As illustrated in FIG. 4, when the doctor performs the imaging operation with the dermoscopic imaging device 30 positioned such that a region of interest R1 of the subject S comes at the center of a visual field, the dermoscopic imaging device 30 inserts and removes the polarizing filter 31 into and from the optical path to continuously image the subject S to generate the image P1 and the image N1 illustrated in (a) of FIG. 3. As illustrated in FIG. 4, the image P1 and the image N1 obtained by the dermoscopic imaging device 30 are output from the dermoscopic imaging device 30 to the information processing apparatus 100. The region of interest R1 is a lesion of a patient suspected of a malignant skin tumor. The subject S is a skin surface including the lesion of the patient. A background region R2 is a healthy portion of the subject S and is a region other than the region of interest R1 of the subject S. The image P1 is an image obtained via the polarizing filter 31 by imaging the subject S irradiated with first illumination light. For example, as illustrated in (a) of FIG. 3, a certain structure SW called a shiny white structure might appear in the region of interest R1 in the image P1. The image N1 is an image obtained without using the polarizing filter 31 by imaging the subject S irradiated with second illumination light. In the background region R2 of the image N1, for example, a structure W of the skin surface such as wrinkles might appear as illustrated in (a) of FIG. 3.

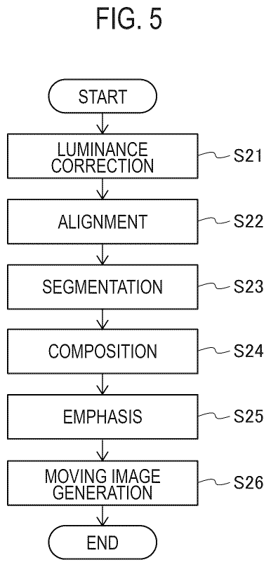

When the image P1 and the image N1 are input, the processor (obtaining unit 110) of the information processing apparatus 100 executes a program to perform the process for obtaining images in step S20. The process for obtaining images in step S20 is processing for obtaining, on the basis of the image P1 and the image N1, an image P5 including the region of interest R1 irradiated with the first illumination light and captured by the imaging element 32 via the polarizing filter 31 and an image N5 including the region of interest R1 irradiated with the second illumination light and captured by the imaging element 32 without using the polarizing filter 31, and is processing for obtaining images to be alternately displayed in the alternate display process in step S30, which will be described later. Note that the image P5 is a dermoscopic image created for display using the polarizing filter 31, and the image N5 is a dermoscopic image created for display without using the polarizing filter 31. More specifically, the process for obtaining images in step S20 is a process illustrated in FIG. 5.

The obtaining unit 110 first performs luminance correction (step S21). Specifically, the obtaining unit 110 corrects luminance of at least one of the image P1 and the image N1 in such a way as to bring luminance of the image P1 and luminance of the background region R2 of the image N1 close to each other. As illustrated in (a) Of FIG. 3, the image P1 and the image N1 have different brightness levels, but both images have two peaks of luminance corresponding to the region of interest R1 (low luminance) and the background region R2 (high luminance) when luminance distribution thereof is represented by histograms. In step S21, in order to equalize the brightness levels of the image P1 and the image N1, the obtaining unit 110 corrects the luminance of at least one of the image P1 and the image N1 using, for example, the histograms so that the peaks of luminance coincide with each other. Note that (b) of FIG. 3 illustrates an image N2 generated by correcting the luminance of the image N1 in accordance with the luminance of the background region R2 of the image P1. The luminance of the background region R2 of the image N2 approximately matches the luminance of the background region R2 of the image P1. Note that, as a result of this correction, the luminance of the region of interest R1 in the image N2 is also close to the luminance of the region of interest R1 in the image P1.

Next, the obtaining unit 110 performs alignment (step S22). Specifically, the obtaining unit 110 processes at least one of the image P1 and the image N2 in such a way as to bring positions of the region of interest R1 in the image P1 and the image N2 close to each other. In step S22, the obtaining unit 110 adjusts positions of the image P1 and the image N2 such that the regions of interest R1 in the image P1 and the image N2 overlap each other, for example, as illustrated in (c) of FIG. 3 and cuts out overlapping regions of the image P1 and the image N2 to generate new images P3 and N3, for example, as illustrated in (d) of FIG. 3. Note that, as an alignment method, any known method such as a method for extracting feature points and matching the feature points can be employed. In addition, when sizes of the region of interest R1 in the image P1 and the image N2 are different from each other, the alignment may be performed in step S22 after enlargement or reduction is performed to make the sizes the same. In addition, the alignment may be performed such that the positions of the region of interest in the images substantially coincide with each other.

The obtaining unit 110 performs segmentation on the images (step S23). Here, a segmentation model obtained by learning the region of interest R1 and the background region R2 in advance is used. Specifically, for example, by inputting the image P3 and the image N3 to the segmentation model, the obtaining unit 110 obtains an image (lesion map M) in which each of pixels is classified into either the region of interest R1 or the background region R2 as illustrated in (e) of FIG. 3.

When the region of interest R1 and the background region R2 are identified from the lesion map M, the obtaining unit 110 performs image composition (step S24). Specifically, the obtaining unit 110 processes at least one of the image P3 and the image N3 on the basis of the lesion map M such that the region of interest R1 in the image P3 or the image N3 and the background region R2 of the other of the image P3 and the image N3 are combined together. In step S24, for example, as illustrated in (f) of FIG. 3, the obtaining unit 110 processes the image N3 and generates a new image N4 such that the region of interest R1 in the image N3 and the background region R2 of the image P3 are combined together.

The obtaining unit 110 further performs image emphasis (step S25). Specifically, the obtaining unit 110 processes at least one of the image P3 and the image N4 in such a way as to emphasize a difference in the region of interest R1 between the image P3 and the image N4. In step S25, for example, as illustrated in (g) of FIG. 3, the obtaining unit 110 generates a combination of new images P5 and N5 in which a structure SW, which is the difference in the region of interest R1 between the image P3 and the image N4, is emphasized by increasing luminance of the structure SW and decreasing luminance of portions of the region of interest R1 other than the structure SW.

Lastly, the obtaining unit 110 generates a moving image (step S26), and ends the process for obtaining images. Specifically, the obtaining unit 110 generates a moving image file that repeatedly plays back the image P5 and the image N5 generated in step S25, for example, at intervals of 1 second. A format of the moving image file is not particularly limited, and may be, for example, an animation graphics interchange format (GIF) or the like.

When the process for obtaining images ends and the moving image file is generated, the processor (display control unit 120) of the information processing apparatus 100 executes a program to perform the alternate display process in step S30. In step S30, the display control unit 120 plays back the moving image file generated in step S26, thereby causing the display device 10 to alternately display the image P5 and the image N5 repeatedly as illustrated in FIG. 4.

As described above, the information processing apparatus 100 causes the display device 10 to automatically alternately display the dermoscopic image (image P5) for display and the dermoscopic image (image N5) for display on the basis of the dermoscopic image (image P1) obtained by the dermoscopic imaging device 30 using the polarizing filter 31 and the dermoscopic image (image N1) obtained without using the polarizing filter 31. With the information processing apparatus 100, therefore, unlike when an observation method is manually switched, it is possible to cause the display device 10 to blink a displayed specific structure that is observed by dermoscopy with the polarizing filter 31 useful for diagnosis of a malignant skin tumor or dermoscopy without the polarizing filter 31 without imposing an excessive burden on the doctor, and it is possible to support the doctor's diagnosis. In other words, the information processing apparatus 100 makes it easier to grasp the state of the region of interest, whereas the conventional technique was to manually switch the observation method each time to observe the subject, which could make it time-consuming to grasp the state of the region of interest.

In addition, the information processing apparatus 100 corrects luminance of a dermoscopic image obtained using the polarizing filter 31 and a dermoscopic image obtained without using the polarizing filter 31 to obtain images to be displayed. In order to enable the doctor to more reliably recognize the above-described blinking display of the specific structure in the alternate display, it is desirable that a change in a portion (referred to as a common portion) other than the specific structure is small between the images to be alternately displayed. Since a luminance difference in the common portion is reduced by bringing luminance close in advance through correction, it is possible to make it easy for the doctor to grasp the blinking display of the specific structure in the alternate display. Note that luminance distribution of the dermoscopic image obtained using the polarizing filter 31 and the dermoscopic image obtained without using the polarizing filter 31 has two peaks corresponding to a healthy portion (background region R2) and a lesion portion (region of interest R1), but the healthy portion is detected with more stable luminance than the lesion portion. By correcting luminance of the images in such a way as to bring the peaks of the luminance of the healthy portion close to each other, luminance levels of the images can be brought closer more stably.

In addition, the information processing apparatus 100 aligns the positions of the region of interest R1 in the dermoscopic image obtained using the polarizing filter 31 and the dermoscopic image obtained without using the polarizing filter 31 to obtain images to be displayed. As a result, since positional deviation between the dermoscopic image obtained using the polarizing filter 31 and the dermoscopic image obtained without using the polarizing filter 31 due to camera shake or the like at a time of continuous imaging is corrected, it is possible to avoid occurrence of vibration of the images due to the positional deviation in the alternate display, and it is possible to reduce a sense of discomfort felt by the user when the user observes the alternately displayed images.

In addition, the information processing apparatus 100 generates a new image by combining the region of interest R1 in the dermoscopic image obtained using the polarizing filter 31 or the dermoscopic image obtained without using the polarizing filter 31 with the background region R2 of the other. In a specific example, a dermoscopic image for display using the polarizing filter 31 is generated by cutting out a lesion portion (region of interest R1) of the dermoscopic image obtained without using the polarizing filter 31 and embedding the lesion portion in a lesion portion (region of interest R1) of the dermoscopic image obtained using the polarizing filter 31. As a result, by alternately displaying the new image (the image N4 in FIG. 3) and the original image (the image P3) including the background region R2 used for the image composition of the new image, the doctor's attention can be directed to the region of interest R1 without being diverted to the background region R2. Unlike when images having a difference in the background region R2 are alternately displayed, therefore, attention is not diverted from the region of interest R1 to the background region R2, and diagnosis efficiency can be improved.

In addition, the information processing apparatus 100 emphasizes a difference in the region of interest R1 between the dermoscopic image obtained using the polarizing filter 31 and the dermoscopic image obtained without using the polarizing filter 31. As a result, a difference in appearance of the lesion portion (region of interest R1) between the dermoscopic image obtained using the polarizing filter 31 and the dermoscopic image obtained without using the polarizing filter 31 can be better observed in the alternate display.

Furthermore, the information processing apparatus 100 generates a moving image file from the dermoscopic image obtained using the polarizing filter 31 and the dermoscopic image obtained without using the polarizing filter 31, and causes the display device 10 to perform the alternate display by playing back the moving image file. As a result, the alternate display can be easily performed at any timing separately from the imaging.

The above-described embodiment has been given as a specific example to facilitate understanding of the invention, and the present invention is not limited to the above-described embodiment, and should be understood as including various modifications and alternative embodiments of the above-described embodiment. For example, it will be understood that the above-described embodiment can be implemented by modifying components without departing from the spirit thereof. In addition, it will be understood that various embodiments can be implemented by appropriately combining a plurality of components disclosed in the above-described embodiment. Furthermore, a person skilled in the art may understand that various embodiments can be implemented by removing some of all the components shown in the embodiment or adding some components to the components shown in the embodiment.

Although an example in which a dermoscopic image for display using the polarizing filter 31 and a dermoscopic image for display not using the polarizing filter 31 are newly generated from a dermoscopic image captured by the dermoscopic imaging device 30 using the polarizing filter 31 and a dermoscopic image captured without using the polarizing filter 31 has been described in the above-described embodiment, the dermoscopic image for display using the polarizing filter 31 may be an image including a region of interest imaged by the imaging element 32 via the polarizing filter 31 and irradiated with the first illumination light, and the dermoscopic image for display not using the polarizing filter 31 may be an image including a region of interest imaged by the imaging element 32 without using the polarizing filter 31 and irradiated with the second illumination light. The dermoscopic image for display using the polarizing filter 31 and the dermoscopic image for display not using the polarizing filter 31, therefore, may be a dermoscopic image captured by the dermoscopic imaging device 30 using the polarizing filter 31 and a dermoscopic image captured without using the polarizing filter 31. Although an example has been described in which the luminance correction, the alignment, the segmentation, the image composition, the image emphasis, and the moving image generation are performed in the process for obtaining images in the above-described embodiment, it is sufficient that the positions of the region of interest in the alternately displayed dermoscopic images substantially coincide with each other, and these processes are arbitrary processes in the process for obtaining images, and need not necessarily be performed. In the process for obtaining images, these processes may be selectively combined together, or processes other than these processes may be additionally performed.

In the above-described embodiment, an example has been described in which the dermoscopic imaging device 30 continuously images the subject S and generates a dermoscopic image using the polarizing filter 31 and a dermoscopic image not using the polarizing filter 31. Although the positional deviation between the images can be suppressed by generating the images through continuous imaging, the dermoscopic image using the polarizing filter 31 and the dermoscopic image not using the polarizing filter 31 need not necessarily be generated through continuous imaging. It is sufficient that the dermoscopic image using the polarizing filter 31 and the dermoscopic image not using the polarizing filter 31 be images obtained by imaging the same subject S, and may be separately imaged, instead. In addition, it is sufficient that the dermoscopic image using the polarizing filter 31 and the dermoscopic image not using the polarizing filter 31 be images obtained by imaging the same subject S, and may be imaged by different devices, instead.

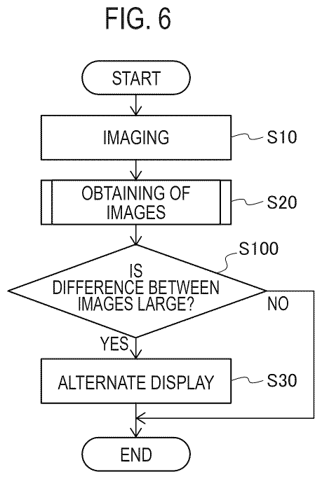

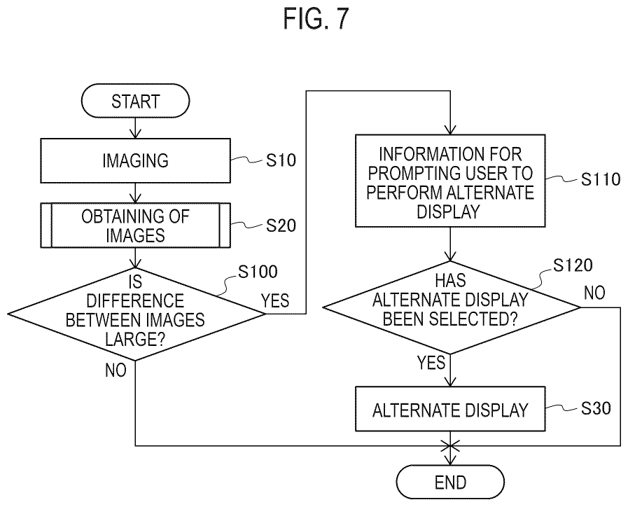

Although an example in which the alternate display is automatically started after imaging has been described in the above-described embodiment, the alternate display may be performed when a predetermined condition is satisfied, instead. For example, as illustrated in FIG. 6, after the process for obtaining images (step S20), the information processing apparatus 100 may determine whether or not the difference between the obtained images is sufficiently large (step S100), and perform the alternate display if the difference is sufficiently large (step S30). That is, when the difference between the images is small and the specific structure cannot be sufficiently visually recognized even if the alternate display is performed, the alternate display may be abandoned. Furthermore, for example, as illustrated in FIG. 7, if the difference between the images obtained through the process for obtaining images is sufficiently large, the information processing apparatus 100 may cause the display device 10 to display information for prompting the user to perform the alternate display (step S110) and, if the user selects the alternate display (step S120), perform the alternate display (step S30). That is, even if the difference between the images is large, the alternate display is not performed in a case where the user does not desire, and the alternate display may be performed only in a case where the user explicitly requests. Note that although not particularly limited, the difference between the images may be evaluated, for example, using differences in pixel values between the images integrated by the region of interest R1, or may be evaluated using the number of pixels (area) in which a difference between pixel values is a predetermined value or larger.

Although an example in which the dermoscopic image using the polarizing filter 31 and the dermoscopic image not using the polarizing filter 31 are alternately displayed has been described, it is sufficient that the images to be alternately displayed include the dermoscopic image using the polarizing filter 31 and the dermoscopic image not using the polarizing filter 31, and the images to be alternately displayed may further include other images. For example, in addition to the dermoscopic image using the polarizing filter 31 and the dermoscopic image not using the polarizing filter 31, an UV image may be alternately displayed at a predetermined cycle, or the dermoscopic image using the polarizing filter 31 or the dermoscopic image not using the polarizing filter 31 and the UV image may be alternately displayed. In addition, difference information regarding the region of interest R1 between the dermoscopic image using the polarizing filter 31 and the dermoscopic image not using the polarizing filter 31, which are alternately displayed, may be displayed after the dermoscopic image using the polarizing filter 31 and the dermoscopic image not using the polarizing filter 31 or before the dermoscopic image using the polarizing filter 31 and the dermoscopic image not using the polarizing filter 31. That is, the difference information may be displayed in order for the user to check which part of the region of interest R1 should be focused on in the alternate display of the dermoscopic image using the polarizing filter 31 and the dermoscopic image not using the polarizing filter 31. In addition, although an example in which the dermoscopic image using the polarizing filter 31 and the dermoscopic image not using the polarizing filter 31 are repeatedly displayed by playing back the moving image file in the alternate display has been described, the alternate display need not necessarily be performed using the moving image file. The alternate display may be performed by sequentially displaying still images, instead.

In the above-described embodiment, although not particularly mentioned, magnification of the images to be alternately displayed may be appropriately changed by digital zoom, and for example, the alternate display may be performed after the region of interest R1 is automatically enlarged to a maximum magnification that fits in the image. In addition, although an example in which the information processing apparatus 100 performs the obtaining of images and the alternate display after images are input from the dermoscopic imaging device 30 has been described in the above-described embodiment, the obtaining of images and the alternate display may be performed at any timing selected by the user, instead. In addition, although an example in which the information processing apparatus 100 alternately displays the images if at least the predetermined condition is satisfied after the obtaining of images has been described, the obtaining of images and the alternate display may be separated from each other, instead. For example, the information processing apparatus 100 may be configured to be able to change whether or not to perform the alternate display by making a setting after the obtaining of images. In addition, the information processing apparatus 100 may enable the user to set a display cycle of the alternate display.

Although an example in which the information processing apparatus 100 performs the alternate display on the basis of the information obtained from the dermoscopic imaging device 30 has been described, the dermoscopic imaging device 30 itself may perform the alternate display, instead. A processor (processing unit) of the dermoscopic imaging device 30 may operate as the obtaining unit 110 and the display control unit 120 to perform the alternate display on a monitor of the dermoscopic imaging device 30. That is, the diagnosis of a malignant skin tumor may be supported by performing the alternate display using the dermoscopic imaging device 30 alone. In addition, the dermoscopic imaging device 30 may be arranged at least between the subject and the imaging element when the imaging is performed using the polarizing filter 31, and may be arranged between a light source (not illustrated) and the subject. In addition, separate polarizing filters may be arranged in an illumination optical path and a detection optical path.

What is claimed is:

1. An information processing apparatus comprising one or more processors configured to:
acquire a first image including a region of interest which is irradiated with first illumination light and imaged by an imaging element via a polarizing filter, and a second image including the region of interest which is irradiated with second illumination light and imaged by the imaging element without using the polarizing filter, and
cause a display to switch between the first image and the second image in a state in which a position of the region of interest in the first image and a position of the region of interest in the second image substantially coincide with each other.

2. The information processing apparatus according to claim 1, wherein
the one or more processors correct luminance of at least one of the first image and the second image in such a way as to bring luminance of background regions of the first image and the second image close to each other.

3. The information processing apparatus according to claim 1, wherein
the one or more processors process at least one of the first image and the second image in such a way as to bring the positions of the region of interest in the first image and the second image close to each other.

4. The information processing apparatus according to claim 1, wherein
the one or more processors process at least one of the first image and the second image such that the region of interest in the first image or the second image and the background region in the other of the first image and the second image are combined together.

5. The information processing apparatus according to claim 1, wherein
the one or more processors process at least one of the first image and the second image in such a way as to emphasize a difference in the region of interest between the first image and the second image.

6. The information processing apparatus according to claim 1, wherein
the one or more processors:
generate a moving image file that alternately and repeatedly plays back the first image and the second image, and
cause the display to switch between the first image and the second image and repeatedly display the first image and the second image by playing back the moving image file.

7. The information processing apparatus according to claim 1, further comprising:
an imaging unit that includes the polarizing filter and that generates the first image and the second image by continuously imaging the region of interest while inserting and removing the polarizing filter into and from an optical path; and
the display.

8. A display control method used by a computer to perform a process comprising:
acquiring a first image including a region of interest which is irradiated with first illumination light and imaged by an imaging element via a polarizing filter and a second image including the region of interest which is irradiated with second illumination light and imaged by the imaging element without using the polarizing filter; and
causing a display unit to switch between the first image and the second image in a state in which a position of the region of interest in the first image and a position of the region of interest in the second image substantially coincide with each other.

9. A system for processing information, comprising:
an information processing apparatus configured to: acquire a first image including a region of interest which is irradiated with first illumination light and imaged by an imaging element via a polarizing filter, and a second image including the region of interest which is irradiated with second illumination light and imaged by the imaging element without using the polarizing filter, and
a display configured to switch between the first image and the second image in a state in which a position of the region of interest in the first image and a position of the region of interest in the second image substantially coincide with each other.
